(19) United States
(12) Patent Application Publication
(10) Pub. No.: US 2019/0024775 A1
(43) Pub. Date: Jan. 24, 2019

(54) Drive shaft, driveshaft, driving shaft, propeller shaft (prop shaft), or Cardan shaft to be used for various types of bicycles, tricycles, quadracycles, unicycles, infinitely wheeled cycles, mopeds, and motorized bicycles (whether propelled solely by human input and/or partial/full input by human input, electricity, gas, or other energy means). All cycle type terms now referred to as “bicycles”

(71) Applicant: Edward C. Van Zanten, Reading, MA (US)

(72) Inventor: Edward C. Van Zanten, Reading, MA (US)

(21) Appl. No.: 15/449,930

(22) Filed: Mar. 4, 2017

(51) Int. Cl. F16H 57/021; F16D 3/06; F16H 57/00; B62M 17/00; B62M 11/02

(52) U.S. Cl. CPC F16H 57/021; F16D 3/06; B62M 11/02; B62M 17/00; F16H 57/0025

(57) ABSTRACT

The invention is a drive shaft, driveshaft, driving shaft, propeller shaft (prop shaft), or Cardan shaft to be used for various types of bicycles, tricycles, quadracycles, unicycles, infinitely wheeled cycles, mopeds, and motorized bicycles (whether propelled solely by human input and/or partial/full input by human input, electricity, gas, or other energy means). All cycle type terms now referred to as “bicycles”. Gears and bearings are mounted within a structural housing at the power input location and the power output location. A shaft is intermediary to the front and rear gear/bearing structures. This shaft can be fixtured on either end with CV joints. Ultimately, gear alignment is at the heart of an efficient, long lasting driveshaft system. Gear alignment has been a core issue with other bicycle shaft drives prior to or currently on the market. Other driveshaft systems have not expressed the importance of a stiff system which begins with the bicycle frame fixture mounting points. The optimum sequence is the following: stiff frame fixtures accept stiff shaft housing which then supports proper type of bearings. This then optimizes gear alignment. Our floating shaft (claim 5) prevents any significant transmission of axial load which may occur due to bicycle frame bending under load. The result: a driveshaft system that can consistently deliver power to the wheels and give the operator a virtually maintenance-free riding experience.

### BACKGROUND

Since the beginning of bicycle usage, bicycles have typically been propelled by a chain, belt, or shaft. Shaft drive for bicycles was pursued by a good number of manufacturers in the late 1800's. Due to performance and reliability issues associated with system weight, imprecise gear meshing friction, lack of multiple gear drivetrains, etc., the chain driven bicycle became the favored form of final drive configuration for the majority of bicycling applications. Shaft drive is a final drivetrain type offered on certain bicycles available for sale currently where it enjoys the advantage of easy isolation from the moisture and abrasives in the environment and reduction in exposure to the end user to a grimy chain and pull-in points. However, many design deficiencies remain that prevent widespread use across all bicycle applications and brands. Pinnacle Motion, LLC, has identified the root cause of these deficiencies and leveraged advancements in materials science and manufacturing, along with a fresh look at machine design to eliminate these issues and allow bicycle companies (and end user consumers alike) to trust and have confidence in shaft drive as a final drivetrain choice and preference.

### BRIEF SUMMARY OF THE INVENTION

A drive shaft, driveshaft, driving shaft, propeller shaft (prop shaft), or Cardan shaft to be used for various types of bicycles, tricycles, quadracycles, unicycles, infinitely wheeled cycles, mopeds, and motorized bicycles (whether propelled solely by human input and/or partial/full input by human input, electricity, gas, or other energy means). All cycle type terms now referred to as “bicycles”.

### BRIEF DESCRIPTION OF THE DRAWINGS

FIGS. 1 & 2 show the floating shaft design (claim #1)

FIGS. 3 & 4 illustrate the alignment boxes (claim #2)

FIGS. 5, 6, 6.1, 6.2, and 6.3 present the prototype shaft drive unit

FIG. 7 shows an extruded aluminum T-slot channel (claim #3). This could be used in conjunction with our cartridge style method of mounting the shaft drive unit in the bicycle frame.

FIG. 8 shows a cross section of the shaft drive system

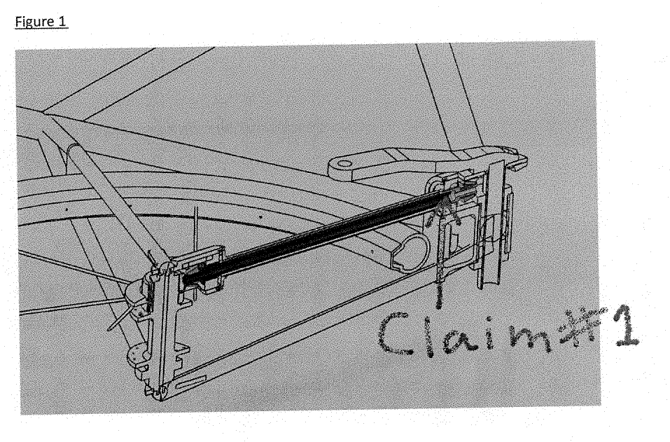

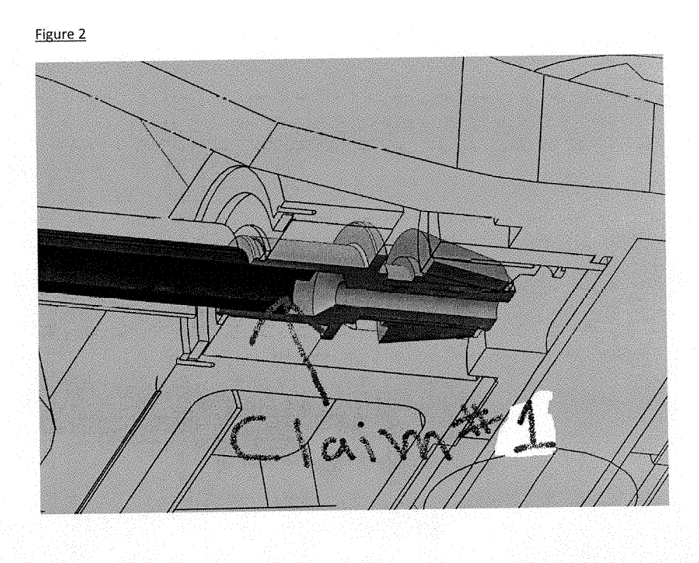

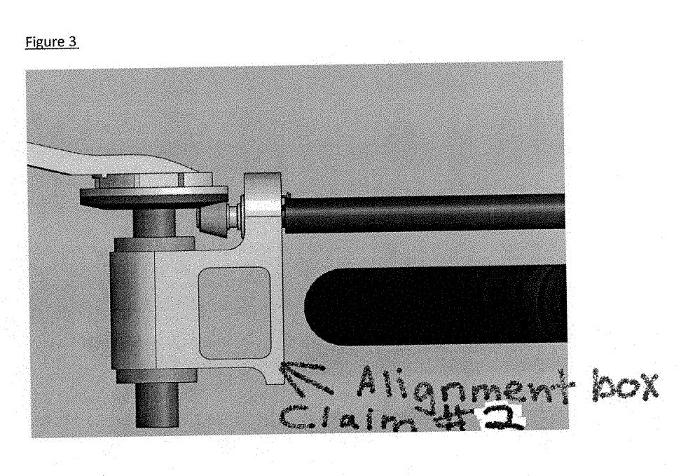

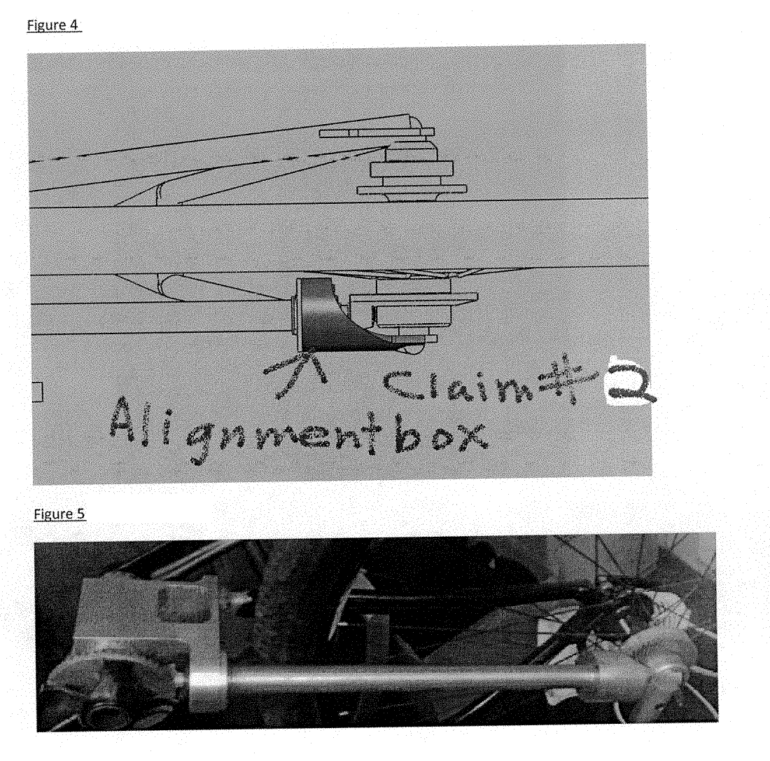

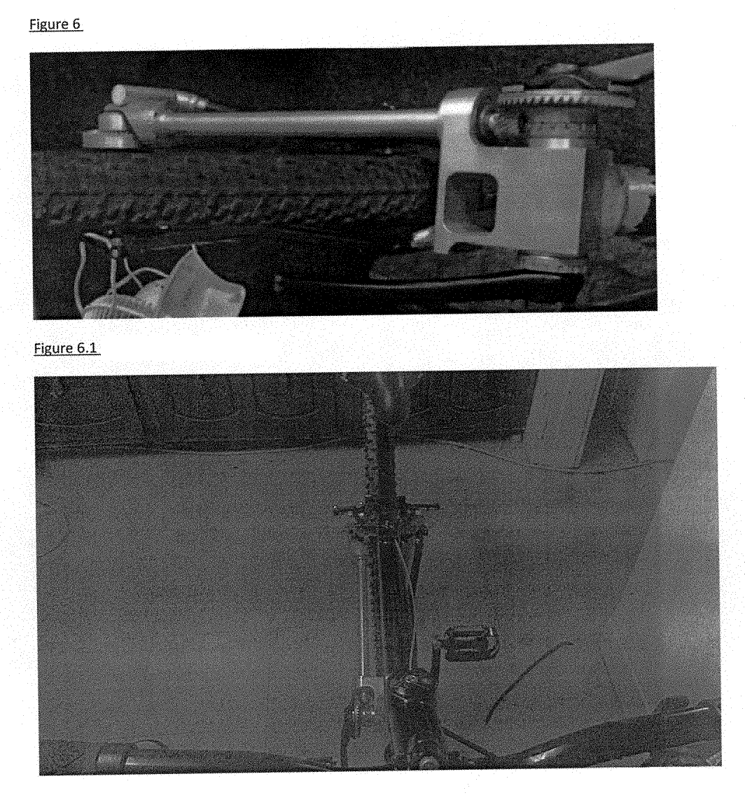

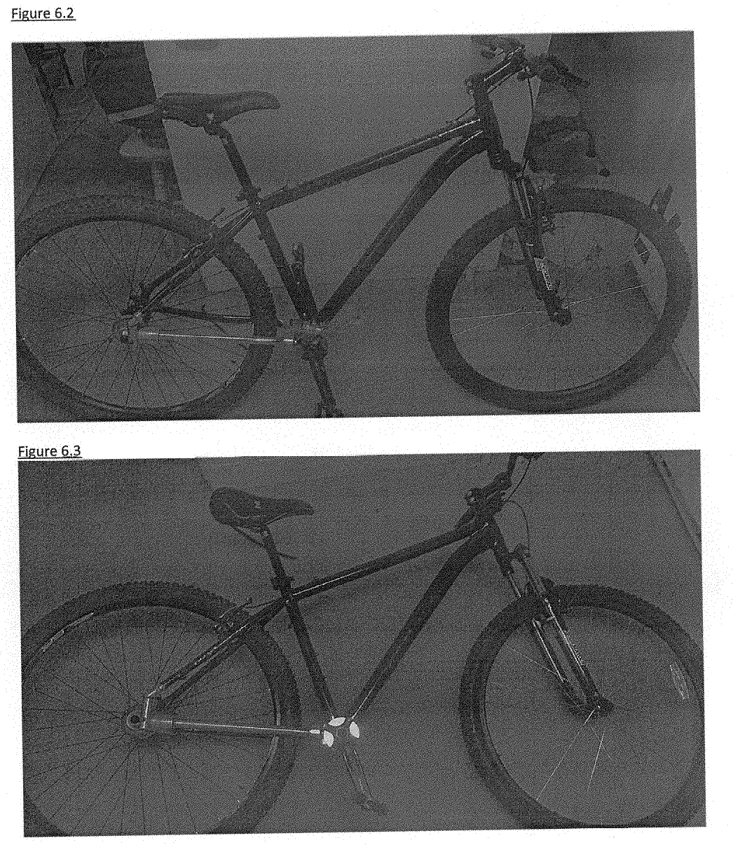

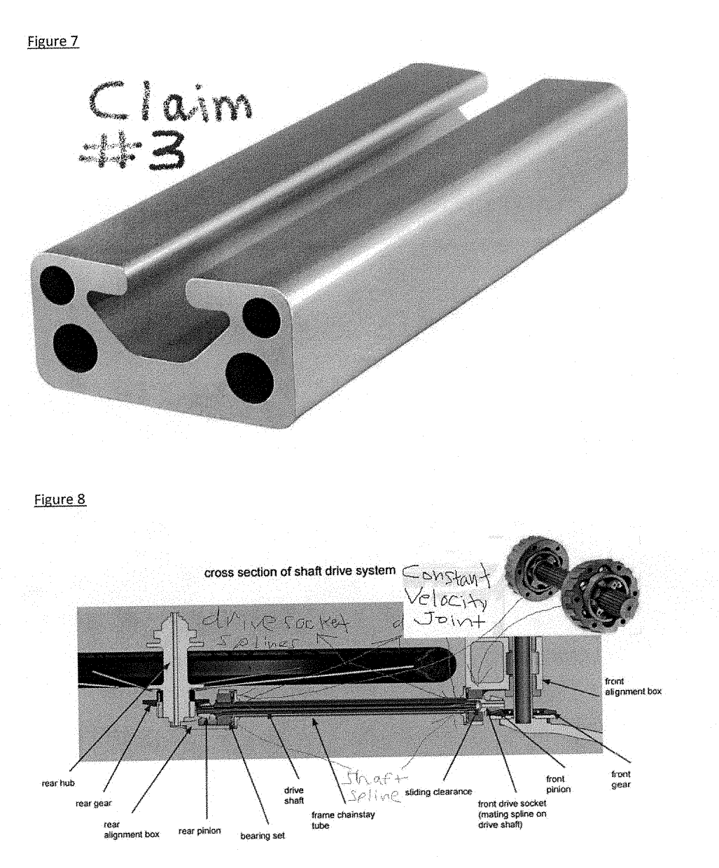

### DETAILED DESCRIPTION AND BEST MODE OF IMPLEMENTATION

Materials may include, but are not limited to: aluminum, steel, titanium, carbon fiber. The most popular driveshaft bicycle system on the market until about 2 years ago was the Sussex branded driveshaft (ultimately owned by Dynamic Bicycles company). Dynamic Bicycles no longer sells the bicycle driveshaft. There are some design flaws that were exposed through actual field riding. Our design aims to improve upon these deficiencies. Beixo is the only main brand of bicycle shaft drive still on the market, but shares many of the same fundamental design flaws as the Sussex design. We feel we should be granted a full utility patent based upon these improvements summarized below.

Bearings wore out quickly. Gear meshing inherently induces residual loading beyond the tangential portion which is the useful portion responsible for transmitting power through the gear set. The radial portion creates moments at the bearing when the bearing is offset from the gear. The Sussex design uses two radial bearings placed back to back on the front pinion gear, but the bearing type is not correct to handle axial loads and thus can lead to premature system failure. The single row radial bearing used in Sussex was not designed to react out these moments. We consider this a design flaw which we've resolved in our design by using two rows, separated by some distance, per gear to react out these moments. In addition, the axial (thrust) load into the bearing is relatively high compared to the radial load. The deep groove radial ball bearing is not the best selection for this. We chose an angular contact bearing as one of the two bearings in our set. A spherical tapered roller bearing or other style of tapered roller bearing is optimal in handling radial and thrust loads. In regards to lubrication, an oil bath should allow for more consistent lubrication than grease. Gear alignment is critical for efficiency and longevity.

The tolerance on gear offset for a nice set of bevel gears can be in the thousandths of an inch. This has to be maintained while under load. The gears themselves have to minimize flex and the supporting structure must be rigid. In particular, the rear triangle of a bike can flex maybe 0.250″. Let's assume the center to center distance between the rear axle and bottom bracket changes 0.125″. The Sussex design rigidly mounts the rear gear set to the front gear set thru the drive shaft. They bolt the pinion gear directly to the driveshaft, so as the frame flexes and rear axle comes closer to the bottom bracket, it could drive the front pinion into the front gear. We've eliminated any axial load transmission through the shaft by allowing the shaft to “float”. See claims section for more information regarding this. The gear set is positioned using the several other parts which have their accompanying manufacturing tolerances. These tolerances are additive. In our design we've eliminated parts in this tolerance stack to help reduce the assembly's effect on the gear meshing. In particular, we employ what we call “alignment boxes” which are both the bottom bracket and front pinion housings machined out of a single block of aluminum eliminating a tolerance stack and fasteners. The Sussex design chainstay is threaded into the bearing housing. This effectively leaves the chainstay length undetermined leading to potential user error when trying to install the system with proper gear offset. Even though the Beixo brand shaft drive doesn't thread the chainstay into the bearing housing, their design doesn't allow any float of the driveshaft and thus can experience the same effect of the pinion gear driving into the front gear.

Retrofitting is the next topic area. The Sussex and Beixo system were designed to retrofit to an existing 1.37″ bottom bracket instead of designing from the ground up. The way they clamp into the bottom bracket is susceptible to loosening, creaking and shifting under each pedal stroke. Our system would be welded to traditional frame tubes. The alignment boxes were designed to eliminate deflection at the gear set so we're not constrained by the existing bottom bracket.

1-Gear alignment: Without proper gear alignment, a driveshaft system will not operate smoothly and efficiently. The gear teeth mesh is where the power transfer begins. Everything else plays a supporting role to ensure constant, optimal gear alignment. The optimal sequence is the following: Stiff frame fixtures accept a stiff shaft housing, which then supports the proper type of bearings and ultimately optimizes gear alignment. The result, a driveshaft system that can consistently deliver power to the wheel(s) and give the operator a virtually maintenance-free riding experience.

2-Bottom Bracket: The current eminent supplier retrofits their crank axle to existing frames' bottom bracket. This has the advantage of retrofittability. However, the drawback is a system with an inferior fastening scheme. The system relies only on the compressed interface of the bottom bracket shell faces. Compression is achieved via two opposing plates which sandwich the bottom bracket shell using a set of long unsupported bolts. The deflection between plates due to user crank forces is proportional to bolt length and relies heavily on friction at the mounting surface both of which contribute to premature system misalignment and loosening. Our design leverages existing bottom bracket mounting features in the same manner intended by the frame designer.

3-Bearing type: Angular contact, spherical roller bearing, tapered roller bearing, thrust ball bearing, cylindrical roller bearing, and needle roller bearing

4-Oil bath: used in front gearbox and possibly rear gear box.

5-Floating shaft: prevents any significant transmission of axial load which may occur due to bicycle frame bending under load. The driveshaft includes a splined feature to transmit torque to the pinion gear and includes sufficient clearance to allow for some axial sliding which may occur due to bicycle frame bending under load. This prevents any significant transmission of axial load from the shaft to the gear which would upset the gear mesh and potentially result in premature failure of the gear set. In other words, the driveshaft is shorter than the shaft drive receptacle on either end, thereby reducing axial load.

6-Alignment boxes: by fabricating “alignment boxes” which simultaneously house bearings for both shafts used in the gear set, and machined from a single billet, we reduce the tolerance stack associated with assemblies to operate in an optimal gear meshing scenario. By eliminating the fasteners associated with assemblies we also improve the rigidity of the structure to further maintain gear alignment under load.

7-CV, Constant Velocity Joints: by using a smaller version of a CV joint typically found in automobiles, ATV's (all terrain vehicles), etc., our shaft drive system will be able to counteract the constant flexing forces it receives from frame flex, pedal input, etc. In a typical CV joint design setup, there is one shaft supported by one CV joint on either end of that one shaft. Multiple shaft/CV Joint combinations are possible depending on the use case. These constant velocity joints could be used in both non-suspension and suspension versions of the shaft drive system. No known bicycle shaft drive uses or has used CV joints in its design. No prior art was found regarding the use of CV joints for a bicycle shaft drive system. Therefore, we feel this is the keystone to our utility patentability as it will be able to constantly mitigate flexing forces that have compromised other current or past bicycle shaft drive systems. It is possible that a universal joint(s) may be able to be substituted for a constant velocity joint to achieve the same effect of counteracting flexing forces.

8: A “Cartridge style” shaft drive housing could be used to ensure ease of connecting the driveshaft unit to the bicycle frame and corresponding wheel(s). This would also allow the end consumer to replace a worn out shaft drive system with a replacement with basic tools and relative ease. Claim #8 shows a piece of extruded aluminum with a channel feature. A corresponding “T” channel would be on the bicycle frame mounting fixture to mesh with this channel shown in Claim #8.
